(19) United States
(12) Patent Application Publication
(10) Pub. No.: US 2019/0247867 A1
(43) Pub. Date: Aug. 15, 2019

(54) Wide Mouth Spray Actuator

(71) Applicant: Rust-Oleum Corporation, Vernon Hills, IL (US)

(72) Inventors: Adam P. Morrison, Belvedere, IL (US); Robert McNulty, Vernon Hills, IL (US)

(21) Appl. No.: 16/270,768

(22) Filed: Feb. 8, 2019

Related U.S. Application Data
(60) Provisional application No. 62/628,437, filed on Feb. 9, 2018.
(60) Provisional application No. 62/632,524, filed on Feb. 20, 2018.

(51) Int. Cl. B05B 1/04; B05B 1/12; B05B 3/02

(52) U.S. Cl. CPC B05B 1/04; B05B 3/025; B05B 1/12

(57) ABSTRACT

A spray actuator for use in controlling the flow of a pressurized fluid from a spray can where the actuator includes a body having a top, a shroud having a bottom perimeter and a central passageway oriented parallel to the shroud and a mouth inlet having a cross-sectional area that is smaller a cross sectional area of the slotted outlet wherein a choke point is located in the central passageway.

This application claims priority to U.S. provisional application No. 62/628,437 filed on Feb. 9, 2018 and to U.S. provisional application No. 62/632,524, filed on Feb. 20, 2018 the specifications of each of which are incorporated herein by reference.

### BACKGROUND OF THE INVENTION

### (1) Field of the Invention

This invention concerns wide mouth spray actuators that emit a pressurized fluid at a high rate with a uniform, controlled spray pattern.

### (2) Description of the Art

Spray paint is commonly used to paint various sized items—small to large. Applying paint as a spray to an item can reduce painting time in comparison to painting with a brush. Applying paint as a spray to an item also eliminates the need to use brushes or rollers to apply the paint. Finally, applying paint as a spray to an item, if done properly, can provide a superior surface finish in comparison to brush painted items.

There are paint application issues with conventional spray paint cans however. Commercially available spray paint cans have very small nozzles that emit a focused and compact jet of paint. As a result, it can take a substantial amount of time to paint a large object such as door. In addition, it can be difficult for a novice to paint any item—large or small—with the focused small spray paint jet as pooling and dripping can occur if the user fails to constantly move the can to adjust the orientation of the paint jet. Thus, optimal paint application can take some practice. As a result, there is a need for spray paint cans with actuators that can apply a uniform layer of spray paint to objects in a short period of time by a novice consumer.

### SUMMARY OF THE INVENTION

One aspect of this invention is a spray actuator including a body having a top and a shroud, the shroud including a bottom perimeter and a central passageway having an inlet opening; an expansion chamber located in the central passageway opposite the inlet opening; an expansion chamber outlet opening that is oriented perpendicular to the central passageway inlet opening; and a mouth having a mouth inlet and a slotted outlet, wherein the expansion chamber outlet opening opens into the mouth inlet and wherein the expansion chamber outlet opening has a cross-sectional area that is smaller than the cross sectional area of the slotted outlet.

In another aspect, the actuator includes a throat located between the expansion chamber outlet and the mouth inlet. In another aspect, the throat cross-section has a constant cross-sectional area.

In still another aspect, the expansion chamber outlet is a choke point for of fluid flowing between the spray can stem opening (16) and the mouth inlet (28). In one further aspect, a choke point is created at outlet opening (22) by designing actuator (10) such that one or both of the area of opening (16) from the stem (14) into the expansion chamber and/or the area of the opening of the valve in the can into the hollow stem is larger than the cross-sectional area of expansion chamber outlet opening (22).

Another aspect is a spray can comprising a spray can containing a pressurized fluid and having an internal valve including a hollow stem having an opening; and an actuator including a body having a top and a shroud, the shroud including a bottom perimeter and a central passageway having an inlet opening; an expansion chamber located in the central passageway opposite the inlet opening; an expansion chamber outlet opening that is oriented perpendicular to the central passageway inlet opening; and a mouth having a mouth inlet and a slotted outlet, wherein the expansion chamber outlet opening opens into the mouth inlet and wherein the expansion chamber outlet opening has a cross-sectional area that is smaller than the cross sectional area of the slotted outlet and wherein the spray can hollow stem occupies a portion of the actuator central passageway.

Yet another aspect of this invention is a method of creating a thin uniform fluid spray stream having a width of about 1 inch and a height of up to 6 to 8 using actuators of this invention were the fluid stream dimensions are measured from about 3 to 10 inches from the actuator mouth outlet.

### DESCRIPTION OF THE FIGURES

FIG. 1A and FIG. 1B are side views of a spray can and an actuator where the actuator is detached from the spray can in FIG. 1A and where the actuator is attached to the spray can in FIG. 1B;

FIG. 2 is a side cutaway view of a spray actuator embodiment in which the spray can is oversized in comparison to the actuator;

FIG. 3A, FIG. 3B and FIG. 3C are respectively a front view, a side cutaway view and a side view of a spray actuator embodiment;

FIGS. 4A and 4B are perspective views of a spray actuator including a mouth that rotates at least 90 degrees from a vertical position to a horizontal position;

FIGS. 5A and 5B are perspective views of a spray actuator including a vertical mouth that that pivots 90 degrees—from facing forward to facing upwards;

FIGS. 6A, 6B and 6C are respectively, a front cutaway view, a rear cutaway view, and a side cutaway view of an actuator embodiment;

FIGS. 7A, 7B, 7C, 7D and 7E are respectively an overhead view, a side cutaway view at line R-R, a front view, a side view and a rear view of an actuator embodiment;

FIG. 8 is a side view of an actuator associated with a can filled with pressurized gas or fluid;

FIGS. 9A, 9B, 9C and 9D are side cutaway views of actuators having different mouth opening angles; and

FIGS. 10A and 10B are perspective views of an actuator with a movable (variable) mouth opening angle.

### DESCRIPTION OF THE CURRENT EMBODIMENT

The present invention relates to a wide mouth actuator that, when associated with a container such as a can containing a pressurized fluid, allows users to controllably form and apply a uniform layer of paint of up to 6 to 8 inches or more in length and an inch or more in width with essentially parallel sides to a large area such as a wall or door.

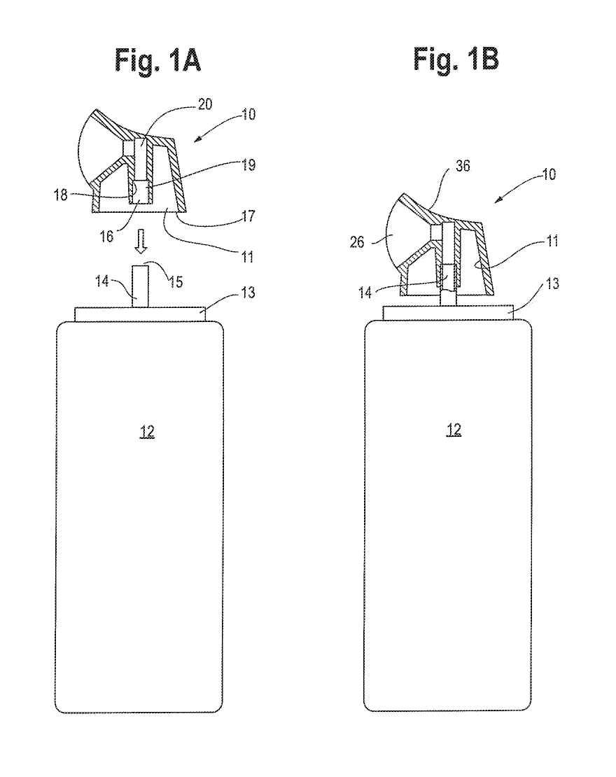

The Figures generally show a spray actuator having an actuator body (10) a top (36) and a shroud (11) with a bottom perimeter (17) that encompasses a complementary spray can top (13) as shown for example in FIGS. 1B, 2 and 6A-6C. Actuator (10) further includes a central passageway (19) having an inlet opening (16) and an expansion chamber (20) at an end of the central passageway (19) opposite inlet opening (16). Expansion chamber (20) further includes an expansion chamber outlet opening (22) that is oriented perpendicular to central passageway inlet opening (16). Actuator (10) further includes a mouth (26) having a mouth inlet (28) and a slotted outlet (30), the mouth forming a graduated opening in which the mouth inlet (28) has a cross-sectional area that is smaller, and in most cases substantially smaller than the cross-sectional area of the slotted outlet (30). In certain embodiments, the cross-sectional area of the mouth inlet (28) will be substantially smaller than the cross-section of mouth slotted outlet (30). For example, mouth inlet (28) may be at least 10%, or at least 25%, or at least 50%, or at least 80% less than the cross-sectional areal of mouth slotted outlet (30).

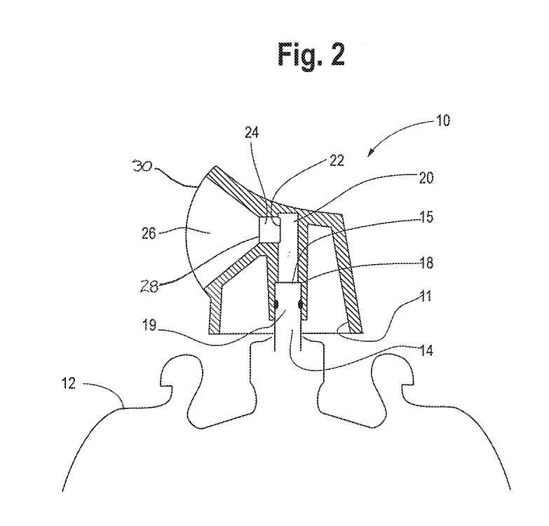

Referring now to the FIGS. 1A, 1B and 2, there is shown a spray can (12) having a top (13) with a hollow central stem (14) inducing a rim (15).

Stem (14) extends vertically from the spray can (12), is hollow and has an opening thereby providing a conduit through which a pressurized fluid flows from spray can (12) and into central passageway (19) when stem (14) is depressed or tilted. This configuration may be reversed with the stem becoming integral to the actuator instead of being integral to the spray can depending on spray can valve style.

Actuator (10) includes a shroud (11) and a central passageway (19) that includes inlet opening (16) which is sized to accept stem (14) and expansion chamber (20) at the opposite inlet opening (16). Referring to FIG. 2, central chamber (19) includes a shoulder (18) against which rim (15) of stem (14) abuts when actuator (10) is associated with stem (14) of spray can (12). Expansion chamber (20) includes an expansion chamber outlet opening (22) which opens into an optional throat (24) or alternatively, when there is no throat, opens directly into the inlet (28) of mouth (26). Mouth (26) further includes a slotted outlet (30) that has a cross-sectional area that is larger than mouth inlet (28) cross-sectional area.

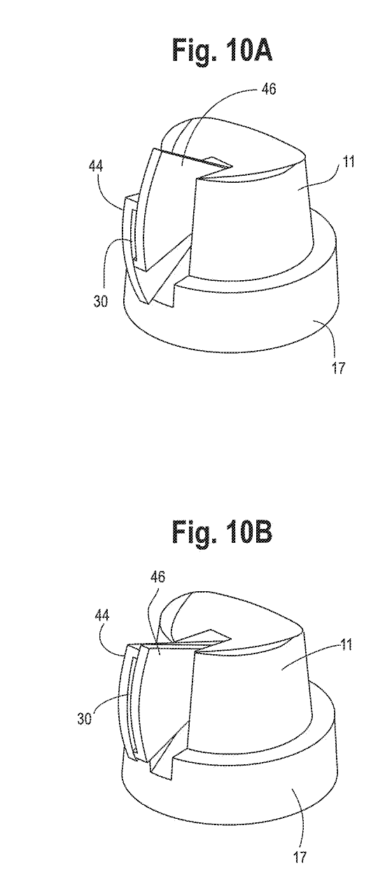

The mouth cross-section may be the same width as expansion chamber outlet opening (22) or it may be less than the opening width depending upon the desired characteristics of the spray. Moreover, the passage or mouth (28) formed between expansion chamber outlet opening (22) and slotted outlet (30) tapers outwardly from inlet (28) to outlet (30). In general, as shown in FIGS. 10A and 10B, the width of passage (28)—the distance between first side wall (32) and second side wall (34) is constant.

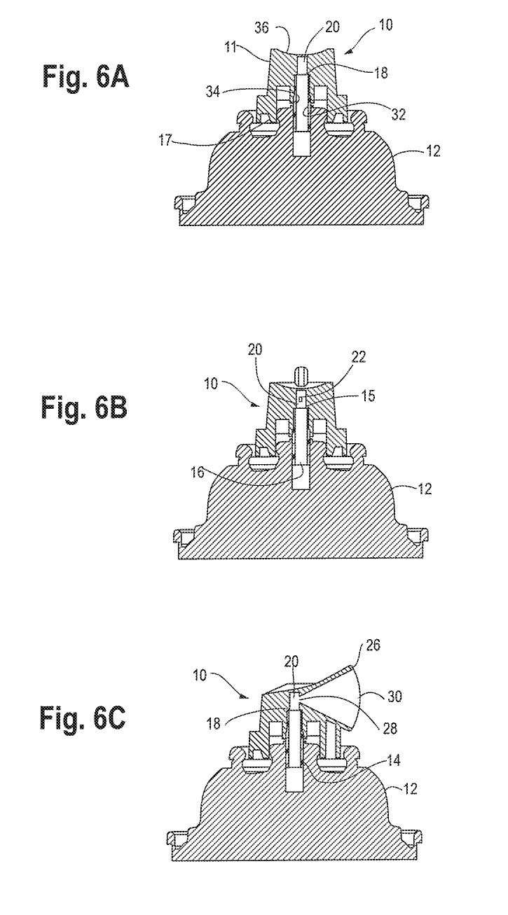

As noted above and as shown, for example, in FIGS. 6A, 6B and 6C, actuator (10) is assembled onto an aerosol spray can (12) of the type commonly used for holding liquids under relatively high pressures for applications such as for spray painting. The spray can has an internal valve (not shown) of conventional design but having openings and passageways large enough to allow for a high volume/rate of flow of fluid/gas such as paint into central chamber (19) of actuator (10). The spray can valve will typically have a siphon tube (not shown) and a valve actuation assembly again of conventional design. Alternatively, actuator (10) may be associated with an inverted can that allows the user to spray the can contents upside down or at any orientation.

When assembled with actuator (10), the amount of fluid that can flow from the spray can via the stem and stem valve may be greater than in normal cans containing a fluid under pressure. To allow for this, the spray can internal valve should be selected from a valve that will not choke fluid flowing out of the spray can before it enters central chamber (19). In addition, inlet opening (16) should be large enough to allow fluid to flow freely into expansion chamber (20) again without choking fluid flow. This allows actuator (10) to dispense a very high volume of fluid over a large surface area in a short period of time—at rates as high as 18 ounces per minute or even higher.

In operation, actuator (10) is depressed manually by applying pressure to the top (36) of actuator (10) thereby causing the valve (not shown) in spray can (12) to open and thereby directing the can liquid contents—which are held under pressure—to be directed from the pressurized spray can (12) through hollow stem (14) and into the expansion chamber (20) portion of central passageway (19). Expansion chamber (20) is sized to be large enough to allow the pressure of the entering fluid to equalize in the chamber such that when the fluid turns ninety degrees from the direction it enters the expansion chamber (20) and enters the actuator mouth inlet (28), the pressure drop of the fluid passing from expansion chamber outlet opening (22) into actuator mouth inlet (28) is essentially uniform across the cross-section of outlet opening (22). The cross-sectional shape of the expansion chamber is not critical to the equalization of fluid pressure but it can have an effect on the ultimate actuator spray pattern. Therefore, the cross-section of expansion chamber outlet opening (22) may be rectangular in shape so that it corresponds generally to the shape of mouth slotted outlet (30). Outlet opening can also be oval in shape.

Actuator embodiments described herein are able to form a uniform fluid spray stream having a variety of shapes with varying lengths and widths. In one aspect, the actuator will form a liquid spray pattern having a width of about 1 inch or more and a height of up to 6 to 8 inches when measuring the fluid spray dimensions on a flat surface located at a distance of from about 3 to 10 inches away from the actuator slotted outlet (30).

Expansion chamber outlet opening (22) functions as both an opening to mouth inlet (28) and as a choke point for of fluid flowing between the spray can stem opening (16) and the mouth inlet (28). By acting as a choke point, when fluid/gas flow is initiated, expansion chamber (20) becomes pressurized with the fluid/gas in a controlled manner which in turn creates a uniform pressure drop across the cross-section of expansion chamber outlet opening (22). The choke point is created at expansion chamber outlet opening (22) by designing actuator (10) such that the area of inlet opening (16) from the stem (14) into expansion chamber (20) and any openings from the spay can valve into the stem is/are larger than the cross-sectional area of expansion chamber outlet opening (22) in order to prevent fluid flow from being choked or held up before it enters expansion chamber (20). In other words, the cross-sectional area of expansion chamber outlet opening (22) must be smaller than the cross-sectional area of inlet opening (16) or any can valve opening through which fluid/gas must flow to reach expansion chamber (20). Moreover, the choke point must be at expansion chamber outlet opening (22) in order to ensure that the fluid that exits slotted mouth (30) is uniform in rate across the entire opening. The choke point is defined as an area or point of significant liquid pressure drop in comparison to pressure losses experienced at other areas where liquid flows through the can valve and actuator.

Generally, the size of expansion chamber outlet opening (22) will be fixed. However, in one optional aspect, the size of expansion chamber outlet opening (22) can be varied to vary the pressure drop across the opening and thereby alter the volumetric flow rate of the fluid exiting spray can. The volumetric fluid flow rate can be controlled by, for example, placing a valve—such as a gate valve—across expansion chamber outlet opening (22) that that can be moved to expand and contract the opening width and thereby the cross-section of expansion chamber outlet opening (22).

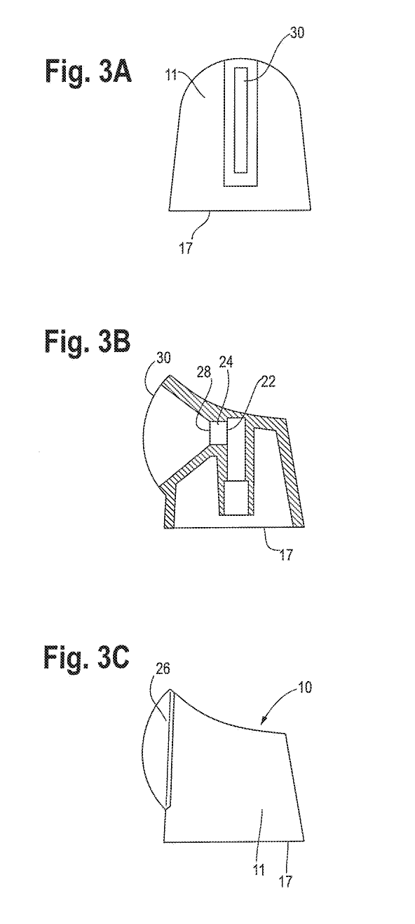

In another aspect of this invention, expansion chamber outlet opening (22) may exit into an optional throat (24) (See FIG. 3B)—a short passage—optionally having a constant cross-section—which in turn opens into mouth inlet (28). Alternatively, as shown in FIG. 2 for example, expansion chamber outlet opening (22) will open directly into mouth opening (28).

Mouth slotted outlet (30) and expansion chamber outlet opening (22) can each have fixed cross-sections to provide optimal performance. In one aspect, one or both of the cross-sectional area of slotted outlet (30) and expansion chamber outlet opening (22) can vary (in width, height or both) and by doing so can change the fluid or gas spray pattern emitted from slotted outlet (30).

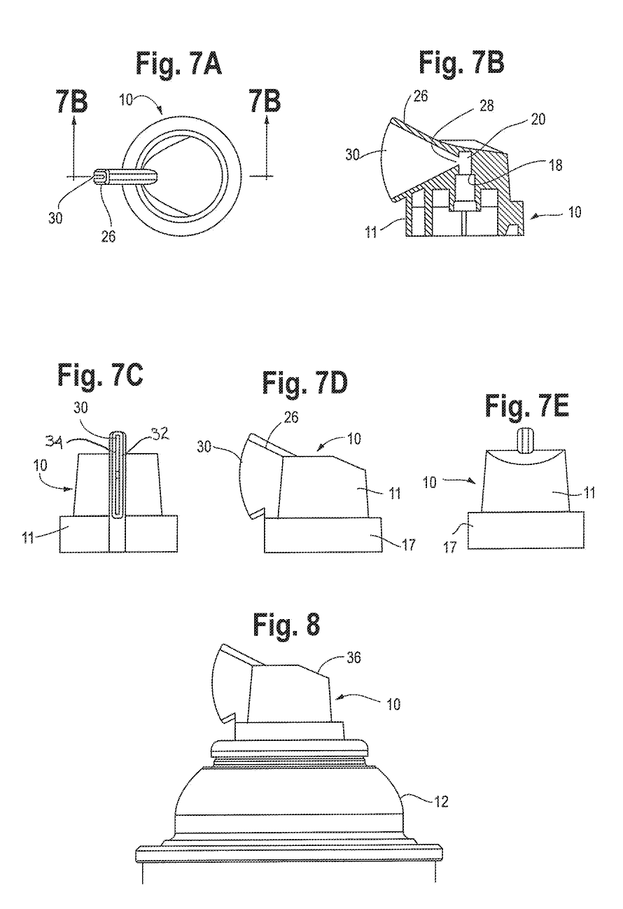

As shown for example in FIGS. 7A and 7C, slotted outlet (30) is in the form of a blade opening—a narrow elongated slit—to provide a broad flat uniform stream of fluid. The width of mouth outlet—the distance between the first side wall (32) of mouth (26) and opposing second side wall (34) of mouth (26) can be fixed or in can be adjustable in order to set or vary the fluid flow rate and/or the pattern—the width and height dimension(s)—of the fluid exiting slotted outlet (30).

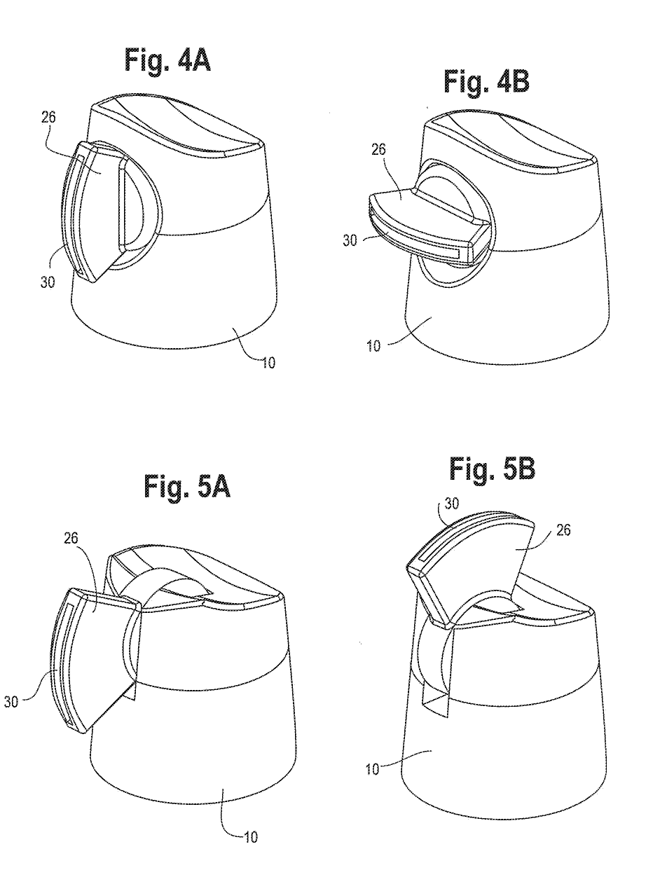

In another aspect, actuator mouth (26) can rotate at least ninety 90° degrees (See FIGS. 4A and 4B)—from a horizontal to a vertical position and back. This allows the user to set the orientation of the slotted outlet (30) with respect to spray can (12) for ease of use.

Another aspect, shown in FIGS. 5A and 5B, allows actuator mouth (26) including slotted outlet (30) to pivot 90 degrees through the vertical axis—towards and away from spray can (12) to allow spray in both 90 degrees to the can and in line with the can (See FIGS. 5A and 5B) or at any angle (orientation) in between. In still another embodiment, the actuator mouth can both rotate horizontally and be pivoted vertically up to 90 degrees or used in any orientation in between.

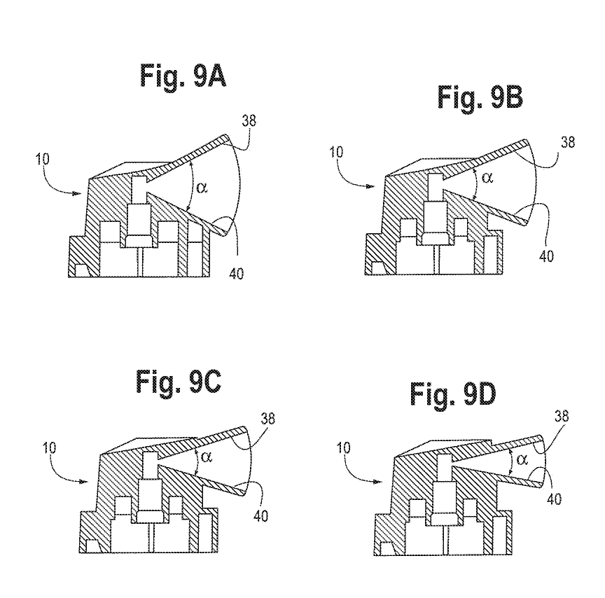

Actuators with mouths having different angular dimensions are shown in FIGS. 9A, 9B, 9C and 9D. In the figures, the expansion chamber outlet opening (22) is the same dimension for all embodiments while the mouth slotted outlet (30) dimension—the angle (α) between the mouth top wall (38) and the mouth bottom wall (40) becomes smaller in each progressing view. Generally the angle (α) between the mouth opening top wall (38) and bottom wall (40) may range from greater than zero degrees and more typically greater than about 10 degrees to about 90 degrees. The mouth opening angle can even be larger than 90 degrees in certain embodiments.

An actuator with a mouth (28) including a first vane (44) and a second opposing vane (46) is shown in FIGS. 10A and 10B. First vane (42) and second vane (44) are movable laterally with respect to one another where moving one or both vanes reduces or enlarges the slotted outlet dimension (α)—depending upon the direction of movement—by varying the angle between mouth top wall (38) and mouth bottom wall (40).

The actuator of the present invention may be fabricated from conventional materials including metals and plastics. In one aspect, actuator (10) is an injection molded thermoplastic polymer. Useful materials, including polymer are those that are known to be compatible with paint and may further be resistant to solvents commonly contained in paint.

It will be understood that the present invention has been described above purely by way of example, and modification of detail can be made within the scope of the invention.

What is claimed is:

1. A spray actuator comprising:
a body having a top and a shroud, the shroud including a bottom perimeter and a central passageway having an inlet opening;
an expansion chamber located in the central passageway opposite the inlet opening;
an expansion chamber outlet opening that is oriented perpendicular to the central passageway inlet opening; and
a mouth having a mouth inlet and a slotted outlet, wherein the expansion chamber outlet opening opens into the mouth inlet and wherein the expansion chamber outlet opening has a cross-sectional area that is smaller than the cross sectional area of the slotted outlet.

2. The spray actuator of claim 1 wherein the expansion chamber outlet opening has a cross-sectional area that is at least 50% less than the cross sectional area of the slotted outlet.

3. The spray actuator of claim 1 wherein the expansion chamber outlet opening has a cross-sectional area that is at least 80% less than the cross sectional area of the slotted outlet

4. The spray actuator of claim 1 wherein the mouth cross sectional area tapers outwardly from the mouth inlet to the slotted outlet.

5. The spray actuator of claim 4 wherein the mouth has a top wall and a bottom wall and the mouth taper is an angle (α) of from 10° to 90° between the mouth top wall and the mouth bottom wall.

6. The spray actuator of claim 1 wherein the mouth inlet includes a throat located between the expansion chamber outlet opening and the mouth inlet.

7. The spray actuator of claim 1 wherein the throat has a constant cross-sectional area.

8. The spray actuator of claim 1 wherein the expansion chamber outlet opening is a choke point for of fluid flowing between the actuator inlet opening and the mouth inlet.

9. The spray actuator of claim 8 wherein the expansion chamber outlet opening choke point is the only actuator choke point.

10. The spray actuator of claim 9 wherein the choke point is formed when the cross-sectional area of the expansion chamber outlet opening is greater than the cross section of the openings of each of expansion chamber inlet opening and a stem outlet opening.

11. The spray actuator of claim 1 wherein the mouth has a first side wall and a second side wall wherein the distance between the first side wall and second side wall is constant in the mouth.

12. The spray actuator of claim 1 wherein the spray actuator is associated with a can having an internal valve and hollow stem such that the hollow stem is occupies a portion of the actuator central passageway.

13. The spray actuator of claim 1 wherein the mouth slotted outlet cross-sectional area is variable.

14. The spray actuator of claim 1 wherein the expansion chamber outlet opening cross-sectional area is variable.

15. The spray actuator of claim 1 wherein the mouth slotted outlet cross-sectional area is variable and wherein the expansion chamber outlet opening cross-sectional area is variable.

16. A spray can comprising:
a spray can containing a pressurized fluid and having an internal valve including a hollow stem having an opening; and
an actuator including a body having a top and a shroud, the shroud including a bottom perimeter and a central passageway having an inlet opening;
an expansion chamber located in the central passageway opposite the inlet opening;
an expansion chamber outlet opening that is oriented perpendicular to the central passageway inlet opening; and
a mouth having a mouth inlet and a slotted outlet, wherein the expansion chamber outlet opening opens into the mouth inlet and wherein the expansion chamber outlet opening has a cross-sectional area that is smaller than the cross sectional area of the slotted outlet and wherein the spray can hollow stem occupies a portion of the actuator central passageway.

17. The spray can of claim 16 wherein in use, a fluid stream is formed having a width of up to 1 inch and a height of up to 6 to 8 inches when measured from about 3 to 10 inches from the actuator mouth outlet.

18. The spray can of claim 16 wherein the fluid exits the actuator at a rate of at least 18 ounces per minute.

19. The spray can of claim 16 wherein the expansion chamber outlet opening is a choke point for of fluid flowing between the actuator inlet opening and the mouth inlet

20. The spray can of claim 16 wherein the pressurized fluid is paint.
